(19) United States
(12) Patent Application Publication
(10) Pub. No.: US 2026/0037610 A1
(43) Pub. Date: Feb. 5, 2026

(54) APPLICATION PROGRAMMING INTERFACE (API) ACCESS TO RESOURCE BASED ON RESOURCE OWNER IDENTIFIER

(71) Applicant: TELEFONAKTIEBOLAGET LM ERICSSON (PUBL), STOCKHOLM (SE)

(72) Inventors: Cheng Wang, Shanghai (CN); Ferhat Karakoc, Istanbul (TR); Wenliang Xu, Shanghai (CN)

(21) Appl. No.: 18/671,545

(22) Filed: May 22, 2024

(30) Foreign Application Priority Data
May 22, 2023 (WO) PCT/CN2023/095482

(51) Int. Cl. G06F 21/44; G06F 9/50; G06F 9/54

(52) U.S. Cl. CPC G06F 21/44; G06F 9/5033; G06F 9/54

(57) ABSTRACT

Embodiments include methods for application programming interface (API) invoking entity of a communication network. Such methods include sending, to a common API framework (CAPIF) core function (CCF) of the communication network, a request for an access token granting the API invoking entity permission to access a resource, in the communication network, that is owned by a resource owner. The request includes an indication related to the resource owner. Such methods include receiving, from the CCF, an access token in accordance with the request. The access token includes the following: a first identifier associated with the resource owner; and a second identifier associated with the API invoking entity. Such methods include invoking, via an API exposing function (AEF), an API for the resource using the access token. Other embodiments include complementary methods for a CCF and for an AEF.

### TECHNICAL FIELD

The present application relates generally to the field of wireless communication networks, and more specifically to techniques that improve security of application programming interfaces (APIs) used in communication networks.

### INTRODUCTION

Currently the fifth generation (5G) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), ultra-low latency critical communications (URLCC), side-link device-to-device (D2D), and several other use cases. 5G was initially specified in 3GPP Release 15 (Rel-15) and continues to evolve through subsequent releases.

Compared to earlier 4G/LTE systems, 5G systems (5GS) include many new features that require new security mechanisms. For example, 5GS seamlessly integrates non-3GPP access (e.g., via wireless LAN) with 3GPP access (e.g., NR and/or LTE). As such, in 5GS, a user equipment (UE, e.g., wireless device) can access services independent of underlying radio access technology (RAT).

Another change in 5G networks is that traditional peer-to-peer interfaces and protocols found in earlier-generation networks are modified and/or replaced by a Service Based Architecture (SBA) in which Network Functions (NFs) provide one or more services to one or more service consumers. In general, the various services are self-contained functionalities that can be changed and modified in an isolated manner without affecting other services. A network repository function (NRF) allow every NF to discover services offered by other NFs. A network slice selection function (NSSF) enables other NFs to identify a network slice instance that is appropriate for a desired service.

3GPP specifications define multiple northbound application programming interfaces (APIs), including APIs defined in 3GPP TS 23.682 (v18.0.0) and 3GPP TR 26.981 (v17.0.0). To avoid duplication and inconsistency of approach between different API specifications, 3GPP has specified a common API framework (CAPIF) that includes common aspects applicable to any northbound service APIs. Note that the term “northbound API” in this context refers to a service API exposed to higher-layer API invokers, with the term “service API” referring to an interface through which a component of the system exposes its services to API invokers by abstracting the services from the underlying mechanisms.

FIG. 1 illustrates some typical business relationships involved in CAPIF. The API invoker is typically provided by a third-party application provider who has service agreement with a CAPIF provider. The API provider hosts one or more service APIs and has a service API arrangement with CAPIF provider to offer the service APIs to the API invoker. The CAPIF provider and the API provider can be part of the same organization (e.g., PLMN operator), in which case the business relationship between the two is internal to a single organization. The CAPIF provider and the API provider can be part of different organizations, in which case the business relationship between the two must exist.

FIG. 2 is a diagram of a functional model for CAPIF. The CAPIF core function (CCF) is hosted within the PLMN operator network. The API invoker is typically provided by a third-party application provider who has service agreement with a CAPIF provider. The API invoker may reside within the same trust domain as the PLMN operator network. The API exposing function (AEF), the API publishing function (APF), and the API management function of the API provider domain, and collectively referred to as API provider domain functions. AEF is the entity that provides the service communication entry point for service APIs.

An API invoker within the PLMN trust domain interacts with the CAPIF core function via CAPIF-1 reference point and with API provider domain via CAPIF-2 reference point. On the other hand, an API invoker outside of the PLMN trust domain interacts via CAPIF-1e and CAPIF-2e reference points. The API exposing function, the API publishing function, and the API management function interact with the CAPIF core function via CAPIF-3, CAPIF-4, and CAPIF-5 respectively.

3GPP TS 33.122 (v17.1.0) defines a security architecture for CAPIF. One security procedure is authorization of an API invoker by AEF. This procedure is further specified in 3GPP TS 23.222 (v18.1.0) section 8.16 and 3GPP TS 33.122 section 6.5.

3GPP TR 23.700-95 (v19.1.0) and 3GPP TR 33.884 (v1.1.1) introduce a CAPIF feature of resource owner aware northbound API access. If an API invocation results in accessing owned resources, this feature requires authorization from the resource owner in the decision of allowing access to the APIs.

### SUMMARY

3GPP TS 23.502 (v18.1.1) section 4.15.10 describes an application function (AF) specific UE ID retrieval procedure. In this procedure, an AF can fetch a UE ID—specific to that AF—from the network using the IP address assigned to the UE. However, there is currently no way to limit the access to the resources of the UE (i.e., scope of access) by the UE itself. More generally, there currently is no way to limit access by an API invoker—the AF in the network or an application running on the UE—to only UE-related resources owned by the API invoker.

An object of embodiments of the present disclosure to address these and other problems, issues, and/or difficulties associated with limiting resource access to authorized resources owners, thereby facilitating the otherwise-advantageous deployment of SBA in 5G networks.

Some embodiments include exemplary methods (e.g., procedures) for an API invoking entity of a communication network (e.g., 5GC).

These exemplary methods include sending, to a common API framework (CAPIF) core function (CCF) of the communication network, a request for an access token granting the API invoking entity permission to access a resource, in the communication network, that is owned by a resource owner. The request includes an indication related to the resource owner. These exemplary methods include receiving from the CCF an access token in accordance with the request. The access token includes the following:
a first identifier associated with the resource owner; and
a second identifier associated with the API invoking entity.
   These exemplary methods include invoking, via an API exposing function (AEF), an API for the resource using the access token.

In some embodiments, these exemplary methods include receiving an API invocation response from the AEF. In some embodiments, the request also includes the second identifier associated with the API invoking entity.

In some embodiments, the API invoking entity is the resource owner and the indication related to the resource owner is one of the following: the second identifier associated with the API invoking entity, or an explicit indication that the request is for accessing the API invoking entity's own resource. In other embodiments, the API invoking entity is different from the resource owner and the indication related to the resource owner is the first identifier associated with the resource owner.

Other embodiments include exemplary methods (e.g., procedures) for a CAPIF core function (CCF) of a communication network (e.g., 5GC).

These exemplary methods include receiving, from an API invoking entity, a request for an access token granting the API invoking entity permission to access a resource, in the communication network, that is owned by a resource owner. The request includes an indication related to the resource owner. These exemplary methods include obtaining a first identifier associated with the resource owner and a second identifier associated with the API invoking entity. These exemplary methods include generating an access token that includes the following: the first identifier; and the second identifier. These exemplary methods include sending the access token to the API invoking entity, in accordance with the request.

In some embodiments, the second identifier is obtained from the request. In other embodiments, the second identifier is obtained from the communication network, when the request does not include the second identifier.

In some embodiments, these exemplary methods include performing an authentication procedure with the API invoking entity based on the request. Also, one of the following applies:
the second identifier is obtained from the communication network during or after the authentication procedure; or
the second identifier in the request is authenticated during the authentication procedure.

In some embodiments, the API invoking entity is the resource owner and the indication related to the resource owner is one of the following:
the second identifier associated with the API invoking entity, or
an explicit indication that the request is for accessing the API invoking entity's own resource.
   In some of these embodiments, obtaining the first identifier can include, based on the indication related to the resource owner, setting the first identifier equal to the second identifier.

In other embodiments, the API invoking entity is different from the resource owner and the indication related to the resource owner is the first identifier associated with the resource owner.

Other embodiments include exemplary methods (e.g., procedures) for an AEF of a communication network (e.g., 5GC).

These exemplary methods include receiving, from an API invoking entity, an invocation of an API for a resource, in the communication network, that is owned by a resource owner. The API invocation includes an access token that includes the following:
a first identifier associated with the resource owner; and
a second identifier associated with the API invoking entity; and
   These exemplary methods include authorizing API access by the API invoking entity, but limited to the resource. These exemplary methods include sending an API invocation response to the API invoking entity.

In some embodiments, the API invoking entity is the resource owner. In other embodiments, the API invoking entity is different from the resource owner.

In some of the embodiments summarized above, the API invoking entity is an application function (AF) in or associated with the communication network, and the second identifier is an AF identifier. In other of the embodiments summarized above, the API invoking entity is an application hosted by a user equipment (UE), and the second identifier is a generic public subscription identifier (GPSI) or subscription public identifier (SUPI) associated with a user subscription to the communication network.

Other embodiments include API invoking entities, CCFs, and AEFs (or network nodes/UEs hosting such functionality) that are configured to perform the operations corresponding to any of the exemplary methods described herein. Other embodiments include non-transitory, computer-readable media storing computer-executable instructions that, when executed by processing circuitry, configure such API invoking entities, CCFs, and AEFs to perform operations corresponding to any of the exemplary methods described herein.

Embodiments of the present disclosure can provide various benefits and/or advantages. For example, embodiments can limit an API invoker's access to resources (e.g., UE resources) owned by the API invoker or by a resource owner who has authorized the API invoker, thereby improving security by eliminating and/or restricting access to confidential, personal, and/or proprietary information. More generally, embodiments improve security of CAPIF in 5G networks.

These and other objects, features, and advantages of the present disclosure will become apparent upon reading the following Detailed Description in view of the Drawings briefly described below.

### BRIEF DESCRIPTION OF THE DRAWINGS

FIG. 1 illustrates some typical business relationships involved in a common API framework (CAPIF) for a 3GPP network.

FIG. 2 is a diagram of a functional model for CAPIF.

FIG. 3 shows an exemplary 5G network architecture.

FIG. 4 shows a signaling diagram for an exemplary procedure for API invoker authorization to access service APIs.

FIG. 5 shows a signaling diagram for an exemplary procedure for CAPIF-2e interface authentication and protection using access tokens.

FIG. 6 shows signaling diagram for an exemplary procedure for API invoker authorization based on access tokens, according to various embodiments of the present disclosure.

FIG. 7 illustrates an exemplary method (e.g., procedure) for an API invoker (or invoking entity), according to various embodiments of the present disclosure.

FIG. 8 illustrates an exemplary method (e.g., procedure) for a CAPIF core function (CCF), according to various embodiments of the present disclosure.

FIG. 9 illustrates an exemplary method (e.g., procedure) for an API exposing function (AEF), according to various embodiments of the present disclosure.

FIG. 10 shows a communication system according to various embodiments of the present disclosure.

FIG. 11 shows a UE according to various embodiments of the present disclosure.

FIG. 12 shows a network node according to various embodiments of the present disclosure.

FIG. 13 shows a host computing system according to various embodiments of the present disclosure.

FIG. 14 is a block diagram of a virtualization environment in which functions implemented by some embodiments of the present disclosure may be virtualized.

FIG. 15 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein do not have to be performed in the exact order disclosed, unless an operation is explicitly described as following or preceding another operation and/or it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node, IAB node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is generally used. However, the concepts disclosed herein are not limited to a 3GPP system, and can be applied in any system that can benefit from the concepts, principles, and/or embodiments described herein.

At a high level, the 5G System (5GS) consists of an Access Network (AN) and a Core Network (CN). The AN provides UEs connectivity to the CN, e.g., via base stations such as gNBs or ng-eNBs described below. The CN includes a variety of Network Functions (NF) that provide a wide range of different functionalities such as session management, connection management, charging, authentication, etc.

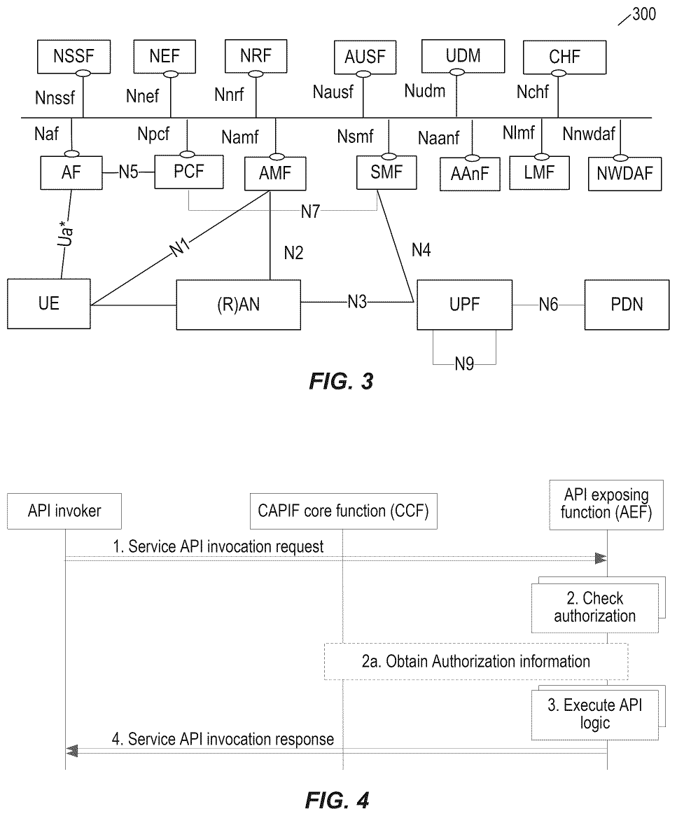

FIG. 3 shows an exemplary non-roaming reference architecture for a 5G network (300). These include the following 3GPP-defined NFs and service-based interfaces:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF) supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, with Namf interface) terminates the RAN CP interface and handles all mobility and connection management of UEs (similar to MME in EPC). AMFs communicate with UEs via the NI reference point and with the RAN (e.g., NG-RAN) via the N2 reference point.
Network Exposure Function (NEF, with Nnef interface) acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (e.g., expected UE behavior) for various UEs.
Network Repository Function (NRF, with Nnrf interface) provides service registration and discovery, enabling NFs to identify appropriate services available from other NFs.
Network Slice Selection Function (NSSF, with Nnssf interface)—a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF, with Nausf interface)—based in a user's home network (HPLMN), it performs user authentication and computes security key materials for various purposes.
Network Data Analytics Function (NWDAF, with Nnwdaf interface) provides network analytics information (e.g., statistical information of past events and/or predictive information) to other NFs on a network slice instance level.
Location Management Function (LMF, with Nlmf interface) supports various functions related to determination of UE locations, including location determination for a UE and obtaining any of the following: DL location measurements or a location estimate from the UE; UL location measurements from the NG RAN; and non-UE associated assistance data from the NG RAN.

The Unified Data Management (UDM) function supports generation of 3GPP authentication credentials, user identification handling, access authorization based on subscription data, and other subscriber-related functions. To provide this functionality, the UDM uses subscription data (including authentication data) stored in the 5GC unified data repository (UDR). In addition to the UDM, the UDR supports storage and retrieval of policy data by the PCF, as well as storage and retrieval of application data by NEF.

The NRF allows every NF to discover the services offered by other NFs, and Data Storage Functions (DSF) allow every NF to store its context. In addition, the NEF provides exposure of capabilities and events of the 5GC to AFs within and outside of the 5GC. For example, NEF provides a service that allows an AF to provision specific subscription data (e.g., expected UE behavior) for various UEs.

The services provided by the various NFs are composed of “service operations”, which are more granular divisions of the overall service functionality. The interactions between service consumers and producers can be of the type “request/response” or “subscribe/notify”. In the latter type, a service consumer NF (or equivalently, “consumer NF”) requests a service producer NF (or equivalently, “producer NF”) to establish a subscription for the service consumer NF to receive notifications from the service producer NF under conditions specified in this subscription.

Generic Bootstrapping Architecture (GBA) was originally specified in Rel-15 and is further defined in 3GPP TS 33.220 (v17.2.0). GBA provides a mechanism to bootstrap authentication and key agreement for application security. The network and the UE derive a Ks key, a Bootstrapping Transaction Identifier (B-TID), and a Ks_NAF key, with the latter being used to secure communication between the UE and a Network Application Function (NAF) located in or outside of the operator network. When the UE wants to use GBA, it constructs Ks_NAF and sends the B-TID to NAF. The NAF requests Ks_NAF by sending the received B-TID to a bootstrapping function (BSF). After the authentication of the NAF by the network, the BSF provides Ks_NAF corresponding to the received B-TID. Thus, the shared key material Ks_NAF is available in UE and NAF to support the security of the communication between them.

The following authentication mechanisms are defined in 3GPP TS 33.220 section 5:
Shared key-based authentication with certificate-based NAF authentication;
Shared key-based mutual authentication between UE and NAF; and
Certificate based mutual authentication between UE and NAF.
   There are also three different GBA modes, denoted by strings “3GPP-bootstrapping”, “3GPP-bootstrapping-uicc” and “3GPP-bootstrapping-digest”.

3GPP Rel-16 introduced a new feature called authentication and key management for applications (AKMA) that is based on 3GPP user credentials in 5G, including the Internet of Things (IoT) use case. More specifically, AKMA leverages the user's AKA (Authentication and Key Agreement) credentials to bootstrap security between the UE and an application function (AF), which allows the UE to securely exchange data with an application server. The AKMA architecture is an evolution of GBA and is further specified in 3GPP TS 33.535 (v17.4.0).

In addition to the NEF, AUSF, and AF shown in FIG. 3 and described above, Rel-16 AKMA also utilizes an anchor function for authentication and key management for applications (AAnF). This function is shown in FIG. 3 with Naanf interface. In general, AAnF interacts with AUSFs and maintains UE AKMA contexts to be used for subsequent bootstrapping requests, e.g., by application functions. At a high level, AAnF is similar to BSF defined for GBA.

In general, security mechanisms for various 5GS protocols rely on multiple security keys. 3GPP TS 33.501 (v16.4.0) specifies these keys in an organized hierarchy. At the top is the long-term key part of the authentication credential and stored in the SIM card on the UE side and in the UDM/ARPF in the user's HPLMN.

A successful Primary Authentication run between the UE and the AUSF in the HPLMN leads to the establishment of K_{AUSF}, the second level key in the hierarchy. This key is not intended to leave the HPLMN and is used to secure the exchange of information between UE and HPLMN, such as for the provisioning of parameters to the UE from UDM in HPLMN. More precisely, K_{AUSF} is used for integrity protection of messages delivered from HPLMN to UE. As described in 3GPP TS 33.501, such new features include the Steering of Roaming (SoR) and the UDM parameter delivery procedures.

K_{AUSF} is used to derive another key, K_{SEAF}, that is sent to the serving PLMN. This key is then used by the serving PLMN to derive subsequent NAS and AS protection keys. These lower-level keys together with other security parameters (e.g., cryptographic algorithms, UE security capabilities, value of counters used for replay protection in various protocols, etc.) constitute the 5G security context as defined in 3GPP TS 33.501. However, KAUSE is not part of the UE's 5G security context that resides in the UE's serving PLMN.

K_{AUSF} is also used by the network and the UE to derive the K_{AKMA} key, an AKMA Key (K_{AKMA}) identifier (A-KID), and any AF keys (K_{AF}) used for communication security authentication or bootstrapping between the UE and respective AFs. A-KID identifies the root key (i.e., K_{AKMA}) used to derive K_{AF}, and includes A-TID (AKMA Temporary UE Identifier) and routing information for the UE's home network. More specifically, A-KID is in the NAI format specified in IETF RFC 7542 clause 2.2, i.e., username@realm. The username part includes the Routing Indicator (RID) and AKMA Temporary UE Identifier (A-TID), and the realm part includes Home Network Identifier. A-TID is derived from K_{AUSF}. For example, A-KID=“A-TID”.“RID”@homenetworkrealm.

When the UE wants to use this feature with an AF, it constructs K_{AF} and A-KID and sends A-KID to the AF, which can be located within or outside of the operator network. The AF requests K_{AF} for the received A-KID from the AAnF via NEF when the AF is located outside the operator's network, or directly from AAnF when the AF is located inside the operator network. After authentication of the AF by the network, the AAnF sends K_{AF} corresponding to A-KID to the AF (directly or via NEF, as the case may be). With a recent enhancement in AKMA, the network also sends the user's Subscription Permanent Identifier (SUPI) to an AF inside the operator network, or the user's generic public subscription identifier (GPSI) to an AF outside the operator network. In this manner, the shared key material K_{AF} is available in UE and AF to support the security of the communication between them.

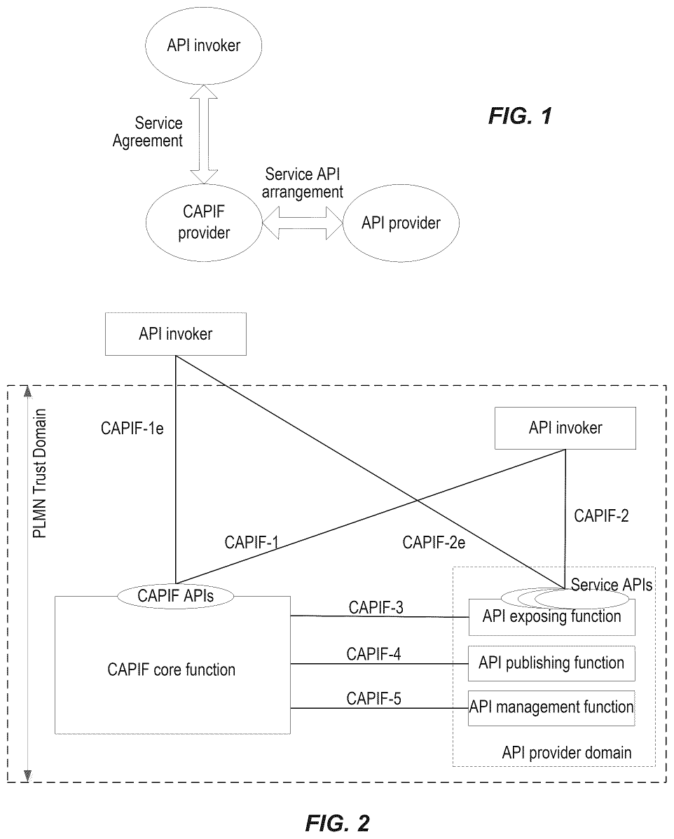

As briefly mentioned above, 3GPP has specified a common API framework (CAPIF) that includes common aspects applicable to any northbound service APIs. CAPIF was described above in relation to FIGS. 1-2, which will be referenced in the following description. 3GPP TS 33.122 (v17.1.0) defines a security architecture for CAPIF, including a procedure for authorization of an API invoker by AEF.

FIG. 4 shows a signaling diagram for an exemplary procedure for API invoker authorization to access service APIs, which is further specified in 3GPP TS 23.222 (v18.1.0) section 8.16 and 3GPP TS 33.122 section 6.5. Although operations shown in FIG. 4 are given numerical labels, this is done to facilitate explanation rather than to require or imply any specific operational order, unless expressly stated otherwise.

In operation 1, the API invoker triggers service API invocation request to the AEF, including the service API to be invoked. Note that the API invoker can trigger several service API invocations asynchronously. The API invoker may provide authorization information in the request.

In operation 2, upon receiving the service API invocation request, the AEF checks whether the API invoker is authorized to invoke that service API, based on the authorization information. In operation 2a, if the AEF does not have information required to authorize service API invocation (e.g., API invoker did not include with the request), the AEF obtains the authorization information from the CAPIF core function (CCF).

In operation 3, the AEF executes the service logic for the invoked service API. In operation 4, the API invoker receives the service API invocation response as a result of the service API invocation.

3GPP TS 33.122 specifies use of OAuth 2.0 protocol for the case where the API invoker includes the authorization information in operation 1. IETF RFC 6749 authorization server, authorization client, and resource server roles for the OAuth 2.0 framework. To obtain authorization information provided in FIG. 4 operation 1, CCF plays the authorization server role while the API invoker plays both the client role and the resource server role.

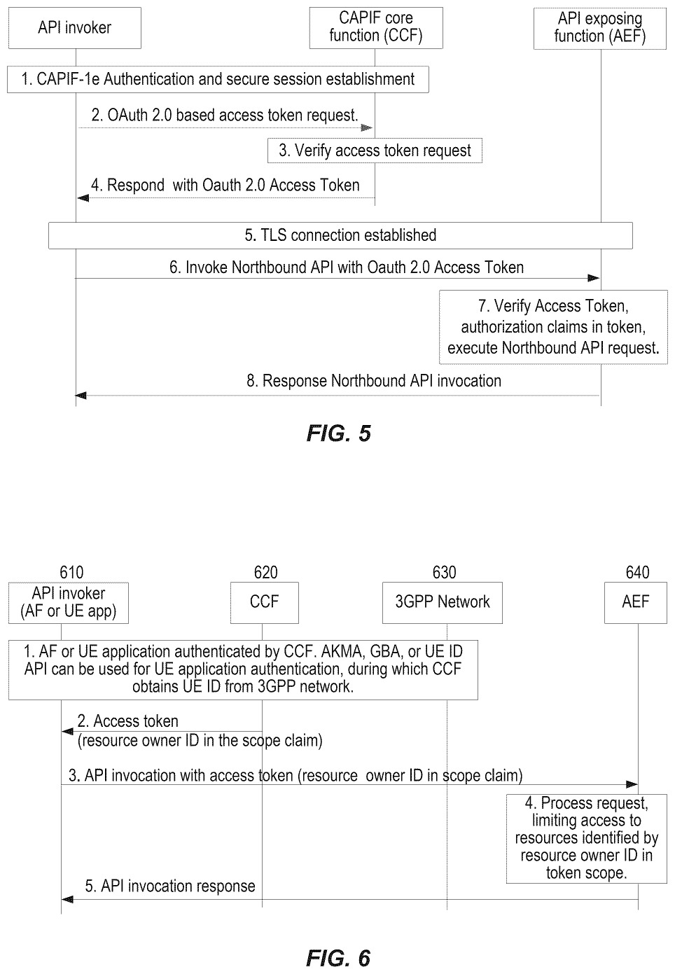

FIG. 5 shows a signaling diagram for an exemplary procedure for CAPIF-2e interface authentication and protection using OAuth 2.0 access tokens, which is further specified in 3GPP TS 33.122 section 6.5.2.3. Although operations shown in FIG. 5 are given numerical labels, this is done to facilitate explanation rather than to require or imply any specific operational order, unless expressly stated otherwise.

In operation 1, CAPIF-1e authentication and secure session establishment is performed as specified in 3GPP TS 33.122 section 6.3.1. In operation 2, after successful establishment of a transport layer security (TLS) session over CAPIF-1e, the API invoker sends an Access Token Request message to the CCF as per IETF RFC 6749. The API invoker may include a CCF-assigned API invoker ID and Onboard_Secret in the access token request message for the CAPIF core function to validate the access token request.

In operation 3, CCF verifies the Access Token Request message per IETF RFC 6749. If CCF successfully verified the Access Token Request message, in operation 4 CCF generates an access token specific to the API invoker and returns it in an Access Token Response message.

In operation 5, on CAPIF-2c, the API invoker authenticates to AEF by establishing a TLS session with the API exposing function based on the authentication and authorization method, specifically server-side (AEF) certificate authentication or certificate-based mutual authentication, as indicated by CAPIF core function. The API invoker and AEF perform other procedures prior to establishment of TLS session, as further specified in 3GPP TS 33.122.

In operation 6, with successful authentication to AEF on CAPIF-2e, the API invoker initiates invocation of a 3GPP northbound API with the AEF. The API invoker sends the access token received from CCF along with the northbound API invocation request, as per IETF RFC 6749. In operation 7, AEF validates the access token, including verifying the integrity of the access token by verifying CCF signature. If validation of the access token is successful, the AEF verifies the API invoker's northbound API invocation request against the authorization claims in access token, ensuring that the API Invoker has access permission for the requested service API.

In operation 8, after successful verification of the access token and authorization claims of the API invoker, the requested northbound API is invoked and the appropriate response returned to the API invoker.

As briefly mentioned above, 3GPP TR 23.700-95 (v19.1.0) and 3GPP TR 33.884 (v1.1.1) introduce a CAPIF feature of resource owner aware northbound API access. If an API invocation results in accessing owned resources, this feature requires authorization from the resource owner in the decision of allowing access to the APIs.

These 3GPP documents also introduce a related feature of allowing applications running on or hosted by a UE (“UE application”) to access UE resources via northbound APIs. 3GPP TS 23.502 (v18.1.1) section 4.15.10 describes a similar feature involving an AF-specific UE ID retrieval procedure. In this procedure, an AF (e.g., in or outside of 5GC) can fetch a UE ID—specific to that AF—from the network using the IP address assigned the UE.

However, there is currently no way to limit the access to the resources of the UE (i.e., scope of access) by the UE itself. More generally, there currently is no way to limit access by an API invoker—the AF in the network or an application hosted by the UE—to only UE-related resources owned by the API invoker.

Embodiments of the present disclosure address these and other problems, issues, and/or difficulties by providing novel, flexible, and efficient techniques in which CCF (acting as authorization server) fetches an identifier (ID) of a resource owner from the 3GPP network during or after the authentication of an API invoker (e.g., AF or UE application). The CCF then issues an access token for the API invoker with this ID included in the scope claim of the access token. The API invoker provides the access token when it invokes the northbound API. Based on the scope claim, the AEF limits the access only to the resources identified by (or associated with) the ID in the access token.

Embodiments of the present disclosure can provide various benefits and/or advantages. For example, embodiments can limit an API invoker's access to resources (e.g., UE resources) owned by the API invoker or by a resource owner who has authorized the API invoker, thereby improving security by eliminating and/or restricting access to confidential, personal, and/or proprietary information. More generally, embodiments improve security of CAPIF in 5G networks.

FIG. 6 shows signaling diagram for an exemplary procedure for API invoker authorization based on access tokens, according to various embodiments of the present disclosure. In particular, the procedure in FIG. 6 involves an API invoker (610), a CCF (620), a 3GPP network (630), and an AEF (640). Although operations shown in FIG. 6 are given numerical labels, this is done to facilitate explanation rather than to require or imply any specific operational order, unless expressly stated otherwise. Note that the signaling in FIG. 6 applies both client credentials and authorization code grant type flows defined in IETF RFC 6749.

In operation 1, the API invoker (i.e., AF or UE application) sends CCF a request for an access token that grants the API invoker access to resources of a resource owner. The API invoker and the CCF execute an authentication procedure. In the case of a UE application, the authorization procedure can be based on AKMA, GBA, UE ID API, or some other relevant method.

During the authentication or after the authentication (if successful), CCF obtains an ID associated with the API invoker. For example, if the API invoker is a UE application, the CCF obtains a generic public subscription identifier (GPSI) or subscription public identifier (SUPI) associated with the user subscription to the 3GPP network. Likewise, if the API invoker is an AF in the 3GPP network, the CCF obtains an AF ID for this AF. The CCF generates an access token with the obtained ID in the “client identifier” field.

In some embodiments, the CCF may obtain the ID from the API invoker's access token request. In other embodiments (e.g., when not included in the request), the CCF may obtain the ID from the 3GPP network. If included in the request, the CCF verifies the API invoker ID (e.g., UE ID or AF ID) and determines the resource owner ID (e.g., resource owner UE ID) to be included in the token. In some embodiments, the API invoker may include a resource owner ID in the access token request.

If the API invoker's request is related to accessing its own resources (i.e., as resource owner), the request may include an explicit resource owner ID which is equal to the authenticated API invoker ID that the CCF obtains from the request or from the 3GPP network. Alternately, the request may exclude a resource owner ID but include an explicit indication that the API invoker's request is for accessing its own resources. In either case, the CCF uses the authenticated API invoker ID as the resource owner ID and includes it in the scope claim of the access token.

If the API invoker's request is related to accessing non-owned resources, the request includes a resource owner ID that is not equal to the authenticated API invoker ID. In this case, the CCF verifies the included resource owner ID with the 3GPP network and includes the verified resource owner ID in the scope claim of the access token.

In operation 2, CCF sends the access token to the API invoker. In operation 3, the API invoker invokes the API of the AEF and includes the access token issued by the CCF. In operation 4, the AEF processes the API invocation request, specifically limiting access to resources associated with the resource owner ID included in the scope claim of the token. In operation 5, the AEF returns an API invocation response to the API invoker (e.g., AF or UE application).

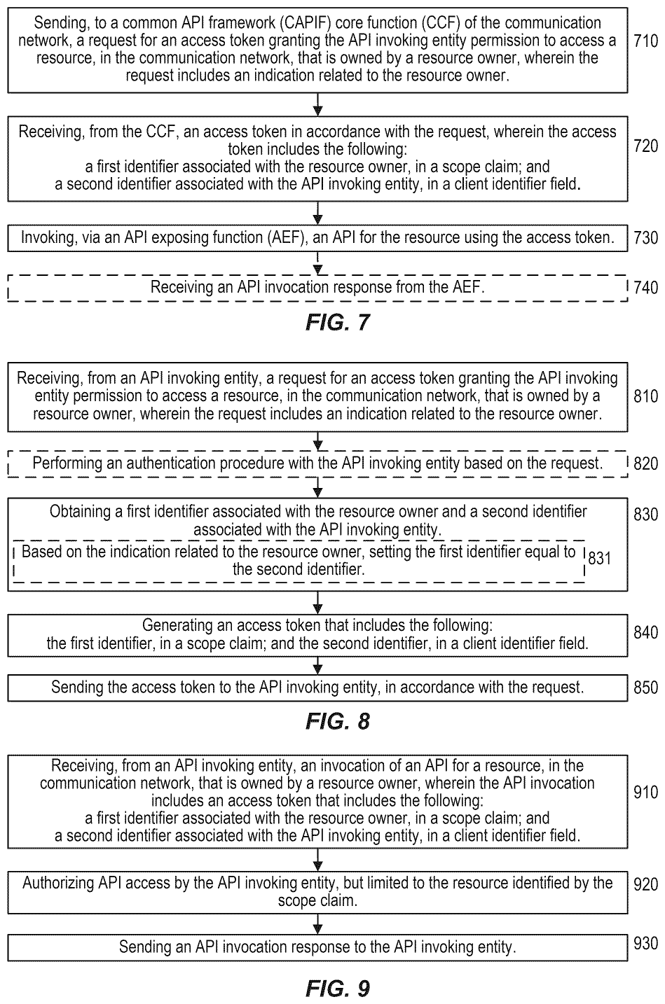

The embodiments described above can be further illustrated with reference to FIGS. 7-9, which depict exemplary methods (e.g., procedures) for an API invoking entity (or invoker), a CCF, and an AEF, respectively. Put differently, various features of the operations described below correspond to various embodiments described above. The exemplary methods shown in to FIGS. 7-9 can be used cooperatively (e.g., with each other and/or with other procedures described herein) to provide benefits, advantages, and/or solutions to problems described herein. Although the exemplary methods are illustrated in to FIGS. 7-9 by specific blocks in particular orders, the operations corresponding to the blocks can be performed in different orders than shown and can be combined and/or divided into operations having different functionality than shown. Optional blocks and/or operations are indicated by dashed lines.

In particular, FIG. 7 illustrates an exemplary method (e.g., procedure) for an API invoking entity of a communication network, according to various exemplary embodiments of the present disclosure. The exemplary method shown in FIG. 7 can be performed by any appropriate API invoking entity (or API invoker, e.g., AF or UE application) such as described herein.

The exemplary method includes the operations of block 730, where the API invoking entity can send, to a common API framework (CAPIF) core function (CCF) of the communication network, a request for an access token granting the API invoking entity permission to access a resource, in the communication network, that is owned by a resource owner. The request includes an indication related to the resource owner. The exemplary method also includes the operations of block 720, where the API invoking entity can receive, from the CCF, an access token in accordance with the request. The access token includes the following:
a first identifier associated with the resource owner, in a scope claim; and
a second identifier associated with the API invoking entity, in a client identifier field.
   The exemplary method also includes the operations of block 730, where the API invoking entity can invoke, via an API exposing function (AEF), an API for the resource using the access token.

In some embodiments, the exemplary method can also include the operations of block 740, where the API invoking entity can receive an API invocation response from the AEF. In some embodiments, the request also includes the second identifier associated with the API invoking entity, in a client identifier field.

In some embodiments, the API invoking entity is the resource owner and the indication related to the resource owner is one of the following: the second identifier associated with the API invoking entity, or an explicit indication that the request is for accessing the API invoking entity's own resource. In other embodiments, the API invoking entity is different from the resource owner and the indication related to the resource owner is the first identifier associated with the resource owner.

In some embodiments, the API invoking entity is an application function (AF) in or associated with the communication network, and the second identifier is an AF identifier. In other embodiments, the API invoking entity is an application hosted by a user equipment (UE), and the second identifier is a generic public subscription identifier (GPSI) or subscription public identifier (SUPI) associated with a user subscription to the communication network.

In addition, FIG. 8 illustrates an exemplary method (e.g., procedure) for a CCF of a communication network, according to various exemplary embodiments of the present disclosure. The exemplary method shown in FIG. 8 can be performed by any appropriate NF such as described herein.

The exemplary method includes the operations of block 810, where the CCF can receive, from an API invoking entity, a request for an access token granting the API invoking entity permission to access a resource, in the communication network, that is owned by a resource owner. The request includes an indication related to the resource owner. The exemplary method includes the operations of block 830, where the CCF can obtain a first identifier associated with the resource owner and a second identifier associated with the API invoking entity. The exemplary method includes the operations of block 840, where the CCF can generate an access token that includes the following: the first identifier, in a scope claim; and the second identifier, in a client identifier field. The exemplary method includes the operations of block 850, where the CCF can send the access token to the API invoking entity, in accordance with the request.

In some embodiments, the second identifier is obtained from a client identifier field of the request. In other embodiments, the second identifier is obtained from the communication network, when the request does not include the second identifier.

In some embodiments, the exemplary method can also include the operations of block 820, where the CCF can perform an authentication procedure with the API invoking entity based on the request. Also, one of the following applies:
the second identifier is obtained from the communication network during or after the authentication procedure; or
the second identifier in the client identifier field of the request is authenticated during the authentication procedure.

In some embodiments, the API invoking entity is the resource owner and the indication related to the resource owner is one of the following:
the second identifier associated with the API invoking entity, or
an explicit indication that the request is for accessing the API invoking entity's own resource.
   In some of these embodiments, obtaining the first identifier in block 830 can include the operations of sub-block 831, where based on the indication related to the resource owner, the CCF can set the first identifier equal to the second identifier.

In other embodiments, the API invoking entity is different from the resource owner and the indication related to the resource owner is the first identifier associated with the resource owner.

In some embodiments, the API invoking entity is an AF in or associated with the communication network and the second identifier is an AF identifier. In other embodiments, the API invoking entity is an application hosted by a UE and the second identifier is a GPSI or SUPI associated with a user subscription to the communication network.

In addition, FIG. 9 illustrates an exemplary method (e.g., procedure) for an API exposing function (AEF) of a communication network, according to various exemplary embodiments of the present disclosure. The exemplary method shown in FIG. 9 can be performed by any appropriate NF such as described herein.

The exemplary method includes the operations of block 910, where the AEF can receive, from an API invoking entity, an invocation of an API for a resource, in the communication network, that is owned by a resource owner. The API invocation includes an access token that includes the following:
a first identifier associated with the resource owner, in a scope claim; and
a second identifier associated with the API invoking entity, in a client identifier field; and
   The exemplary method includes the operations of block 930, where the AEF can authorize API access by the API invoking entity, but limited to the resource identified by the scope claim. The exemplary method includes the operations of block 930, where the AEF can send an API invocation response to the API invoking entity.

In some embodiments, the API invoking entity is the resource owner and the scope claim includes the first identifier. In other embodiments, the API invoking entity is different from the resource owner.

In some embodiments, the API invoking entity is an AF in or associated with the communication network and the second identifier is an AF identifier. In other embodiments, the API invoking entity is an application hosted by a UE, and the second identifier is a GPSI or SUPI associated with a user subscription to the communication network.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

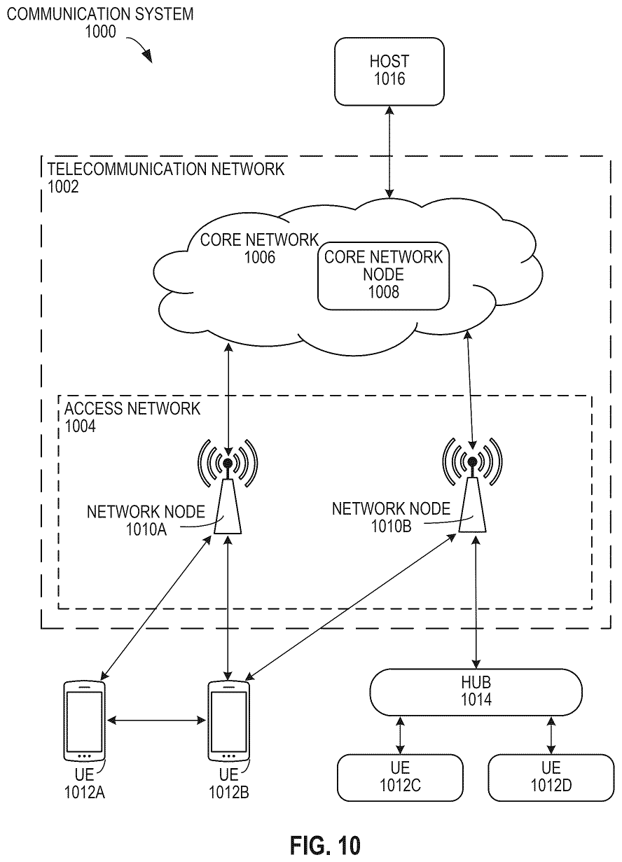

FIG. 10 shows an example of a communication system 1000 in accordance with some embodiments. In this example, communication system 1000 includes a telecommunication network 1002 that includes an access network 1004 (e.g., RAN) and a core network 1006, which includes one or more core network nodes 1008. Access network 1004 includes one or more access network nodes, such as network nodes 1010a-b (one or more of which may be generally referred to as network nodes 1010), or any other similar 3GPP access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, telecommunication network 1002 includes one or more Open-RAN (ORAN) network nodes. An ORAN network node is a node in telecommunication network 1002 that supports an ORAN specification (e.g., a specification published by the O-RAN Alliance, or any similar organization) and may operate alone or together with other nodes to implement one or more functionalities of any node in telecommunication network 1002, including one or more network nodes 1010 and/or core network nodes 1008.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. Network nodes 1010 facilitate direct or indirect connection of UEs, such as by connecting UEs 1012a-d (one or more of which may be generally referred to as UEs 1012) to core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1000 may include any number of wired or wireless networks, network nodes, UEs, and/or any other components or systems that may facilitate or participate in the communication of data and/or signals whether via wired or wireless connections. Communication system 1000 may include and/or interface with any type of communication, telecommunication, data, cellular, radio network, and/or other similar type of system.

UEs 1012 may be any of a wide variety of communication devices, including wireless devices arranged, configured, and/or operable to communicate wirelessly with network nodes 1010 and other communication devices. Similarly, network nodes 1010 are arranged, capable, configured, and/or operable to communicate directly or indirectly with UEs 1012 and/or with other network nodes or equipment in telecommunication network 1002 to enable and/or provide network access, such as wireless network access, and/or to perform other functions, such as administration in telecommunication network 1002.

In the depicted example, core network 1006 connects network nodes 1010 to one or more hosts, such as host 1016. These connections may be direct or indirect via one or more intermediary networks or devices. In other examples, network nodes may be directly coupled to hosts. Core network 1006 includes one or more core network nodes (e.g., 1008) that are structured with hardware and software components. Features of these components may be substantially similar to those described with respect to the UEs, network nodes, and/or hosts, such that the descriptions thereof are generally applicable to the corresponding components of core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1016 may be under the ownership or control of a service provider other than an operator or provider of access network 1004 and/or telecommunication network 1002, and may be operated by the service provider or on behalf of the service provider. Host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local arca network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1002 is a cellular network that implements 3GPP standardized features. Accordingly, telecommunication network 1002 may support network slicing to provide different logical networks to different devices that are connected to telecommunication network 1002. For example, telecommunication network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1012 are configured to transmit and/or receive information without direct human interaction. For instance, a UE may be designed to transmit information to access network 1004 on a predetermined schedule, when triggered by an internal or external event, or in response to requests from access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, hub 1014 communicates with access network 1004 to facilitate indirect communication between one or more UEs (e.g., UE 1012c and/or 1012d) and network nodes (e.g., network node 1010b). In some examples, hub 1014 may be a controller, router, content source and analytics, or any of the other communication devices described herein regarding UEs. For example, hub 1014 may be a broadband router enabling access to core network 1006 for the UEs. As another example, hub 1014 may be a controller that sends commands or instructions to one or more actuators in the UEs. Commands or instructions may be received from the UEs, network nodes 1010, or by executable code, script, process, or other instructions in hub 1014. As another example, hub 1014 may be a data collector that acts as temporary storage for UE data and, in some embodiments, may perform analysis or other processing of the data. As another example, hub 1014 may be a content source. For example, for a UE that is a VR headset, display, loudspeaker or other media delivery device, hub 1014 may retrieve VR assets, video, audio, or other media or data related to sensory information via a network node, which hub 1014 then provides to the UE cither directly, after performing local processing, and/or after adding additional local content. In still another example, hub 1014 acts as a proxy server or orchestrator for the UEs, in particular if one or more of the UEs are low energy IoT devices.

Hub 1014 may have a constant/persistent or intermittent connection to network node 1010b. Hub 1014 may also allow for a different communication scheme and/or schedule between hub 1014 and UEs (e.g., UE 1012c and/or 1012d), and between hub 1014 and core network 1006. In other examples, hub 1014 is connected to core network 1006 and/or one or more UEs via a wired connection. Moreover, hub 1014 may be configured to connect to an M2M service provider over access network 1004 and/or to another UE over a direct connection. In some scenarios, UEs may establish a wireless connection with network nodes 1010 while still connected via hub 1014 via a wired or wireless connection. In some embodiments, hub 1014 may be a dedicated hub—that is, a hub whose primary function is to route communications to/from the UEs from/to network node 1010b. In other embodiments, hub 1014 may be a non-dedicated hub—that is, a device which is capable of operating to route communications between the UEs and network node 1010b, but which is additionally capable of operating as a communication start and/or end point for certain data channels.

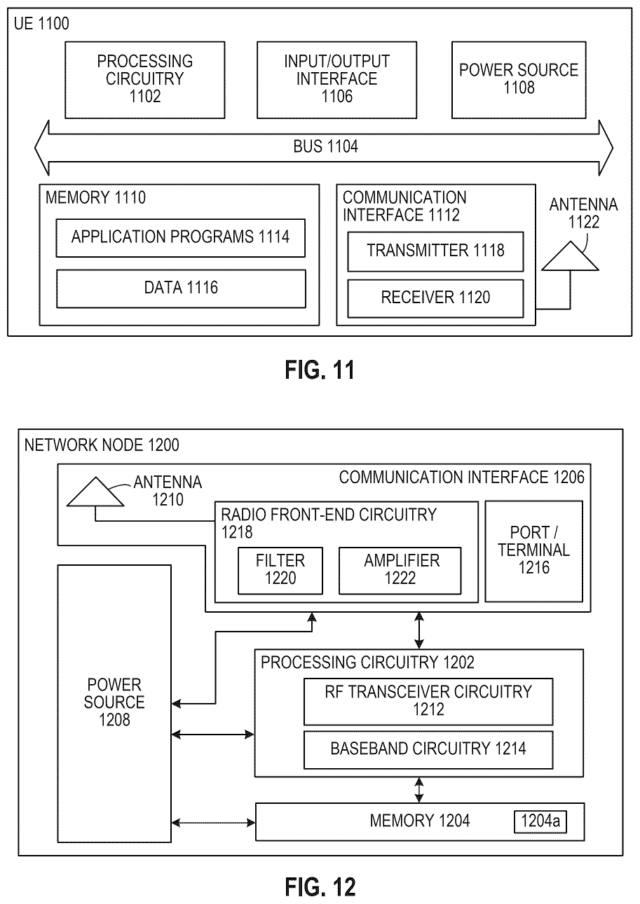

FIG. 11 shows a UE 1100 in accordance with some embodiments. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V21), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

Processing circuitry 1102 is configured to process instructions and data and may be configured to implement any sequential state machine operative to execute instructions stored as machine-readable computer programs in memory 1110. Processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1102 may include multiple central processing units (CPUs).

In the example, input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1108 is structured as a battery or battery pack. Other types of power sources, such as an external power source (e.g., an electricity outlet), photovoltaic device, or power cell, may be used. Power source 1108 may further include power circuitry for delivering power from power source 1108 itself, and/or an external power source, to the various parts of UE 1100 via input circuitry or an interface such as an electrical power cable. Delivering power may be, for example, for charging power source 1108. Power circuitry may perform any formatting, converting, or other modification to the power from power source 1108 to make the power suitable for the respective components of UE 1100 to which power is supplied.

Memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1110 includes one or more application programs 1114, such as an operating system, web browser application, a widget, gadget engine, or other application, and corresponding data 1116. Memory 1110 may store, for use by UE 1100, any of a variety of various operating systems or combinations of operating systems.

Memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1110 may allow UE 1100 to access instructions, application programs and the like, stored on transitory or non-transitory memory media, to off-load data, or to upload data. An article of manufacture, such as one utilizing a communication system may be tangibly embodied as or in memory 1110, which may be or comprise a device-readable storage medium.

Processing circuitry 1102 may be configured to communicate with an access network or other network using communication interface 1112. Communication interface 1112 may comprise one or more communication subsystems and may include or be communicatively coupled to an antenna 1122. Communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, transmitter 1118 and receiver 1120 may be coupled to one or more antennas (e.g., antenna 1122) and may share circuit components, software or firmware, or alternatively be implemented separately.

In the illustrated embodiment, communication functions of communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. Examples of network nodes include, but are not limited to, access points (APs) (e.g., radio access points), base stations (e.g., radio base stations, Node Bs, eNBs, gNBs), and O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1200 includes a processing circuitry 1202, a memory 1204, a communication interface 1206, and a power source 1208. Network node 1200 may be composed of multiple physically separate components (e.g., a NodeB component and a RNC component, or a BTS component and a BSC component, etc.), which may each have their own respective components. In certain scenarios in which network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). Network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, cither alone or in conjunction with other network node 1200 components, such as memory 1204, to provide network node 1200 functionality.

In some embodiments, the processing circuitry 1202 includes a system on a chip (SOC). In some embodiments, the processing circuitry 1202 includes radio frequency (RF) transceiver circuitry 1212 and/or baseband processing circuitry 1214. In some embodiments, RF transceiver circuitry 1212 and baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

Memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. Memory 1204 may store any suitable instructions, data, or information, including a computer program, software, an application including one or more of logic, rules, code, tables, and/or other instructions (collected denoted computer program 1204a, which may be in the form of a computer program product) capable of being executed by the processing circuitry 1202 and utilized by network node 1200. Memory 1204 may be used to store any calculations made by the processing circuitry 1202 and/or any data received via communication interface 1206. In some embodiments, the processing circuitry 1202 and memory 1204 is integrated.

Communication interface 1206 is used in wired or wireless communication of signaling and/or data between a network node, access network, and/or UE. As illustrated, communication interface 1206 comprises port(s)/terminal(s) 1216 to send and receive data, for example to and from a network over a wired connection. Communication interface 1206 also includes radio front-end circuitry 1218 that may be coupled to, or in certain embodiments a part of, antenna 1210. Radio front-end circuitry 1218 comprises filters 1220 and amplifiers 1222. Radio front-end circuitry 1218 may be connected to an antenna 1210 and processing circuitry 1202. The radio front-end circuitry may be configured to condition signals communicated between antenna 1210 and processing circuitry 1202. Radio front-end circuitry 1218 may receive digital data that is to be sent out to other network nodes or UEs via a wireless connection. Radio front-end circuitry 1218 may convert the digital data into a radio signal having the appropriate channel and bandwidth parameters using a combination of filters 1220 and/or amplifiers 1222. The radio signal may then be transmitted via antenna 1210. Similarly, when receiving data, antenna 1210 may collect radio signals which are then converted into digital data by radio front-end circuitry 1218. The digital data may be passed to the processing circuitry 1202. In other embodiments, the communication interface may comprise different components and/or different combinations of components.

In certain alternative embodiments, network node 1200 does not include separate radio front-end circuitry 1218, instead, the processing circuitry 1202 includes radio front-end circuitry and is connected to antenna 1210. Similarly, in some embodiments, all or some of RF transceiver circuitry 1212 is part of communication interface 1206. In still other embodiments, communication interface 1206 includes one or more ports or terminals 1216, radio front-end circuitry 1218, and RF transceiver circuitry 1212, as part of a radio unit (not shown), and communication interface 1206 communicates with baseband processing circuitry 1214, which is part of a digital unit (not shown).

Antenna 1210 may include one or more antennas, or antenna arrays, configured to send and/or receive wireless signals. Antenna 1210 may be coupled to radio front-end circuitry 1218 and may be any type of antenna capable of transmitting and receiving data and/or signals wirelessly. In certain embodiments, antenna 1210 is separate from network node 1200 and connectable to network node 1200 through an interface or port.

Antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, antenna 1210, communication interface 1206, and/or the processing circuitry 1202 may be configured to perform any transmitting operations described herein as being performed by the network node. Any information, data and/or signals may be transmitted to a UE, another network node and/or any other network equipment.

Power source 1208 provides power to the various components of network node 1200 in a form suitable for the respective components (e.g., at a voltage and current level needed for each respective component). Power source 1208 may further comprise, or be coupled to, power management circuitry to supply the components of network node 1200 with power for performing the functionality described herein. For example, network node 1200 may be connectable to an external power source (e.g., the power grid, an electricity outlet) via an input circuitry or interface such as an electrical cable, whereby the external power source supplies power to power circuitry of power source 1208. As a further example, power source 1208 may comprise a source of power in the form of a battery or battery pack which is connected to, or integrated in, power circuitry. The battery may provide backup power should the external power source fail.

Embodiments of network node 1200 may include additional components beyond those shown in FIG. 12 for providing certain aspects of the network node's functionality, including any of the functionality described herein and/or any functionality necessary to support the subject matter described herein. For example, network node 1200 may include user interface equipment to allow input of information into network node 1200 and to allow output of information from network node 1200. This may allow a user to perform diagnostic, maintenance, repair, and other administrative functions for network node 1200.

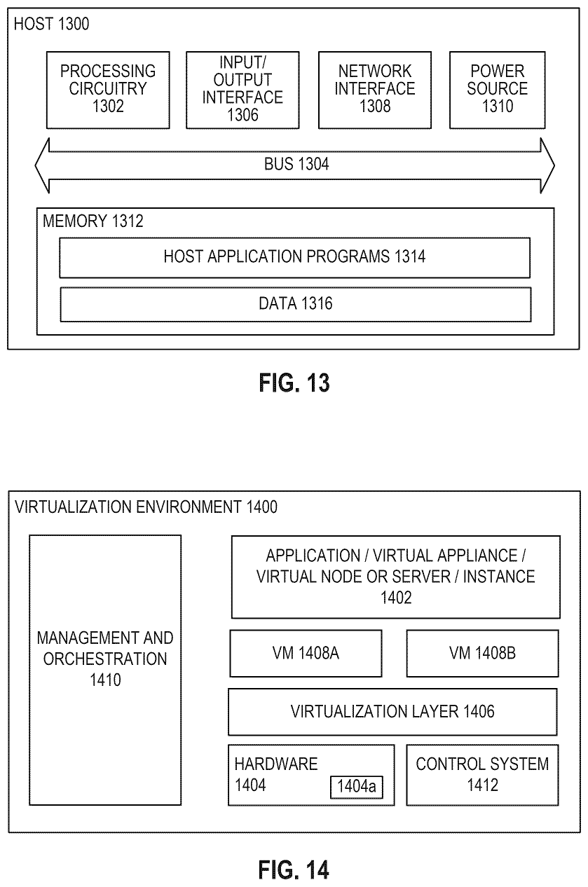

FIG. 13 is a block diagram of a host 1300, which may be an embodiment of host 1016 of FIG. 10, in accordance with various aspects described herein. As used herein, host 1300 may be or comprise various combinations hardware and/or software, including a standalone server, a blade server, a cloud-implemented server, a distributed server, a virtual machine, container, or processing resources in a server farm. Host 1300 may provide one or more services to one or more UEs.

Host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

Memory 1312 may include one or more computer programs including one or more host application programs 1314 and data 1316, which may include user data, e.g., data generated by a UE for host 1300 or data generated by host 1300 for a UE. Embodiments of host 1300 may utilize only a subset or all of the components shown. Host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1314 may also provide for user authentication and licensing checks and may periodically report health, routes, and content availability to a central node, such as a device in or on the edge of a core network. Accordingly, host 1300 may select and/or indicate a different host for over-the-top services for a UE. Host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1400 includes components defined by the O-RAN Alliance, such as an O-Cloud environment orchestrated by a Service Management and Orchestration Framework via an O-2 interface.

Applications 1402 (which may alternatively be called software instances, virtual appliances, network functions, virtual nodes, virtual network functions, etc.) are run in the virtualization environment 1400 to implement some of the features, functions, and/or benefits of some of the embodiments disclosed herein.

Hardware 1404 includes processing circuitry, memory that stores software and/or instructions (collected denoted computer program 1404a, which may be in the form of a computer program product) executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. Virtualization layer 1406 may present a virtual operating platform that appears like networking hardware to the VMs 1408.

VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1408 may be a software implementation of a physical machine that runs programs as if they were executing on a physical, non-virtualized machine. Each VM 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration function 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

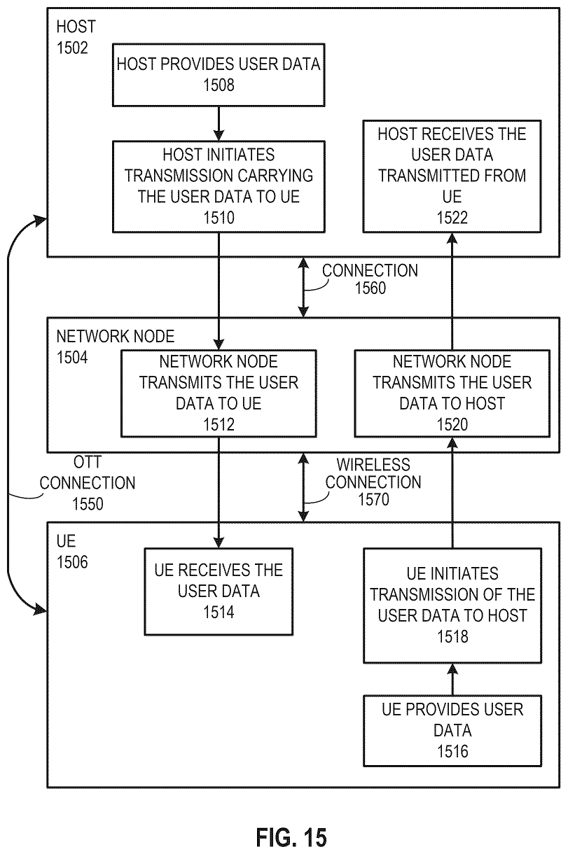

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. Host 1502 also includes software, which is stored in or accessible by host 1502 and executable by the processing circuitry. The software includes a host application that may be operable to provide a service to a remote user, such as UE 1506 connecting via an over-the-top (OTT) connection 1550 extending between UE 1506 and host 1502. In providing the service to the remote user, a host application may provide user data which is transmitted using OTT connection 1550.

Network node 1504 includes hardware enabling it to communicate with host 1502 and UE 1506. Connection 1560 may be direct or pass through a core network (like core network 1006 of FIG. 10) and/or one or more other intermediate networks, such as one or more public, private, or hosted networks. For example, an intermediate network may be a backbone network or the Internet.

UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of host 1502. In host 1502, an executing host application may communicate with the executing client application via OTT connection 1550 terminating at UE 1506 and host 1502. In providing the service to the user, the UE's client application may receive request data from the host's host application and provide user data in response to the request data. OTT connection 1550 may transfer both the request data and the user data. The UE's client application may interact with the user to generate the user data that it provides to the host application through OTT connection 1550.

OTT connection 1550 may extend via a connection 1560 between host 1502 and network node 1504 and via a wireless connection 1570 between network node 1504 and UE 1506 to provide the connection between host 1502 and UE 1506. Connection 1560 and wireless connection 1570, over which OTT connection 1550 may be provided, have been drawn abstractly to illustrate the communication between host 1502 and UE 1506 via network node 1504, without explicit reference to any intermediary devices and the precise routing of messages via these devices.

As an example of transmitting data via OTT connection 1550, in step 1508, host 1502 provides user data, which may be performed by executing a host application. In some embodiments, the user data is associated with a particular human user interacting with UE 1506. In other embodiments, the user data is associated with a UE 1506 that shares data with host 1502 without explicit human interaction. In step 1510, host 1502 initiates a transmission carrying the user data towards UE 1506. Host 1502 may initiate the transmission responsive to a request transmitted by UE 1506. The request may be caused by human interaction with UE 1506 or by operation of the client application executing on UE 1506. The transmission may pass via network node 1504, in accordance with the teachings of the embodiments described throughout this disclosure. Accordingly, in step 1512, network node 1504 transmits to UE 1506 the user data that was carried in the transmission that host 1502 initiated, in accordance with the teachings of the embodiments described throughout this disclosure. In step 1514, UE 1506 receives the user data carried in the transmission, which may be performed by a client application executed on UE 1506 associated with the host application executed by host 1502.

In some examples, UE 1506 executes a client application which provides user data to host 1502. The user data may be provided in reaction or response to the data received from host 1502. Accordingly, in step 1516, UE 1506 may provide user data, which may be performed by executing the client application. In providing the user data, the client application may further consider user input received from the user via an input/output interface of UE 1506. Regardless of the specific manner in which the user data was provided, UE 1506 initiates, in step 1518, transmission of the user data towards host 1502 via network node 1504. In step 1520, in accordance with the teachings of the embodiments described throughout this disclosure, network node 1504 receives user data from UE 1506 and initiates transmission of the received user data towards host 1502. In step 1522, host 1502 receives the user data carried in the transmission initiated by UE 1506.

One or more of the various embodiments improve the performance of OTT services provided to UE 1506 using OTT connection 1550, in which wireless connection 1570 forms the last segment. For example, embodiments can limit an API invoker's access to resources (e.g., UE resources) owned by the API invoker or by a resource owner who has authorized the API invoker, thereby improving security by eliminating and/or restricting access to confidential, personal, and/or proprietary information. More generally, embodiments improve security of CAPIF in 5G networks. By making networks more secure in this manner, embodiments increase the value of OTT services delivered via these secure networks.

In an example scenario, factory status information may be collected and analyzed by host 1502. As another example, host 1502 may process audio and video data which may have been retrieved from a UE for use in creating maps. As another example, host 1502 may collect and analyze real-time data to assist in controlling vehicle congestion (e.g., controlling traffic lights). As another example, host 1502 may store surveillance video uploaded by a UE. As another example, host 1502 may store or control access to media content such as video, audio, VR or AR which it can broadcast, multicast or unicast to UEs. As other examples, host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 1550 between host 1502 and UE 1506, in response to variations in the measurement results. The measurement procedure and/or the network functionality for reconfiguring the OTT connection may be implemented in software and hardware of host 1502 and/or UE 1506. In some embodiments, sensors (not shown) may be deployed in or in association with other devices through which OTT connection 1550 passes; the sensors may participate in the measurement procedure by supplying values of the monitored quantities exemplified above, or supplying values of other physical quantities from which software may compute or estimate the monitored quantities. The reconfiguring of OTT connection 1550 may include message format, retransmission settings, preferred routing etc.; the reconfiguring need not directly alter the operation of network node 1504. Such procedures and functionalities may be known and practiced in the art. In certain embodiments, measurements may involve proprietary UE signaling that facilitates measurements of throughput, propagation times, latency and the like, by host 1502. The measurements may be implemented in that software causes messages to be transmitted, in particular empty or ‘dummy’ messages, using OTT connection 1550 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated claims.

1. A method for an application programming interface, API, invoking entity of a communication network, the method comprising:
sending, to a common API framework, CAPIF, core function, CCF, of the communication network, a request for an access token granting the API invoking entity permission to access a resource, in the communication network, that is owned by a resource owner, wherein the request includes an indication related to the resource owner;
receiving, from the CCF, an access token in accordance with the request, wherein the access token includes the following:
a first identifier associated with the resource owner; and
a second identifier associated with the API invoking entity; and
invoking, via an API exposing function, AEF, an API for the resource using the access token.

2. The method of claim 1, further comprising receiving an API invocation response from the AEF.

3. The method of claim 1, wherein the API invoking entity is the resource owner and the indication related to the resource owner is one of the following:
the second identifier associated with the API invoking entity, or
an explicit indication that the request is for accessing the API invoking entity's own resource.

4. The method of claim 1, wherein the API invoking entity is different from the resource owner and the indication related to the resource owner is the first identifier associated with the resource owner.

5. The method of claim 1, wherein the request also includes the second identifier associated with the API invoking entity.

6. (canceled)

7. The method of claim 1, wherein the API invoking entity is an application hosted by a user equipment, UE, and the second identifier is a generic public subscription identifier, GPSI, or subscription public identifier, SUPI, associated with a user subscription to the communication network.

8. A method for a common application programming interface, API, framework core function, CCF, of a communication network, the method comprising:
receiving, from an API invoking entity, a request for an access token granting the API invoking entity permission to access a resource, in the communication network, that is owned by a resource owner, wherein the request includes an indication related to the resource owner;
obtaining a first identifier associated with the resource owner and a second identifier associated with the API invoking entity;
generating an access token that includes the following:
the first identifier; and
the second identifier; and
sending the access token to the API invoking entity, in accordance with the request.

9. The method of claim 8, wherein the second identifier is obtained from one of the following:
the request; or
from the communication network, when the request does not include the second identifier.

10. The method of claim 9, further comprising performing an authentication procedure with the API invoking entity based on the request, wherein one of the following applies:
the second identifier is obtained from the communication network during or after the authentication procedure; or
the second identifier in the request is authenticated during the authentication procedure.

11. The method of claim 8, wherein the API invoking entity is the resource owner and the indication related to the resource owner is one of the following:
the second identifier associated with the API invoking entity, or
an explicit indication that the request is for accessing the API invoking entity's own resource.

12. The method of claim 11, wherein obtaining the first identifier comprises, based on the indication related to the resource owner, setting the first identifier equal to the second identifier.

13. (canceled)

14. The method of claim 8, wherein the API invoking entity is an application function, AF, in or associated with the communication network, and the second identifier is an AF identifier.

15. The method of claim 8, wherein the API invoking entity is an application hosted by a user equipment, UE, and the second identifier is a generic public subscription identifier, GPSI, or subscription public identifier, SUPI, associated with a user subscription to the communication network.

16. A method for an application programming interface, API, exposing function, AEF, of a communication network, the method comprising:
receiving, from an API invoking entity, an invocation of an API for a resource, in the communication network, that is owned by a resource owner, wherein the API invocation includes an access token that includes the following:
a first identifier associated with the resource owner; and
a second identifier associated with the API invoking entity; and
authorizing API access by the API invoking entity, but limited to the resource; and
sending an API invocation response to the API invoking entity.

17. The method of claim 16, wherein the API invoking entity is the resource owner.

18. The method of claim 16, wherein the API invoking entity is different from the resource owner.

19. The method of claim 16, wherein the API invoking entity is an application function, AF, in or associated with the communication network, and the second identifier is an AF identifier.

20. The method of claim 16, wherein the API invoking entity is an application hosted by a user equipment, UE, and the second identifier is a generic public subscription identifier, GPSI, or subscription public identifier, SUPI, associated with a user subscription to the communication network.

21-32. (Canceled)
